(19) United States
(12) Patent Application Publication
(10) Pub. No.: US 2017/0106392 A1
(43) Pub. Date: Apr. 20, 2017

(54) PLAYING FIELD LINE MARKING SYSTEM

(71) Applicant: Bill H. Kehoe, Rockledge, FL (US)

(72) Inventor: Bill H. Kehoe, Rockledge, FL (US)

(21) Appl. No.: 15/298,944

(22) Filed: Oct. 20, 2016

Related U.S. Application Data
(60) Provisional application No. 62/243,831, filed on Oct. 20, 2015.

(51) Int. Cl. B05B 15/04

(52) U.S. Cl. CPC B05B 15/045

(57) ABSTRACT

A system embodying a template for marking all American football field hash and cross marks is provided. The template provides an arm plate and a base plate interconnected by an arm of a predetermined distance. The base plate provides a centrally disposed rectangular cutout for, with a separate marking device, marking the hash and cross marks, wherein the periphery of the base plate in conjunction with the arm plate enable a user to properly locate all the needed hash and cross marks.

### CROSS-REFERENCE TO RELATED APPLICATION

This application claims the benefit of priority of U.S. provisional application No. 62/243,831, filed 20 Oct. 2015, the contents of which are herein incorporated by reference.

### BACKGROUND OF THE INVENTION

The present invention relates to athletic playing field markings and, more particularly, to a system embodying a template for marking playing field lines.

Per rule, American football fields are required to have marking lines applied thereto for laying out boundaries and identifiable areas thereof. For example, marking lines indicating the sidelines, the end zones, every five yard line markers, “hash marks” at one yard intervals between the five yard line markers over the entire length along each sideline and the midfield, and cross marks at every five yard line to indicate the external edge of the midfield hash marks.

Furthermore, the sport of football utilizes various drills for teaching the many techniques of the sport's plurality of playing positions. Typically, such drills require markings at predetermined distances.

Current systems embodying templates for marking lines on a football field have at least one of the following drawbacks: they are bulky, taking up limited storage space; require more than one person to carry out; time consuming; unintentionally drips marking paint when moving between lines because they have more than one cutout; and are inaccurate. Specifically, other systems embodying templates have to be done in a certain order, can not set up any other football drills, and are less accurate because they measure yard line locations using differently size spots marks. Furthermore, other such templates are bigger and more bulky, which makes storage more difficult and in use to line the field. Moreover, other templates have four cutouts or openings in their base, and so when moving between marking lines, such multiple cutouts lead to paint unintentionally dripping on and thus marring the field.

As can be seen, there is a need for a system embodying a template for marking playing field lines that can be used in any order, by one person in a more accurate manner that saves time, wherein such template can be used for marking the playing field of all required hash and cross marks.

### SUMMARY OF THE INVENTION

In one aspect of the present invention, a system embodying a template for marking playing field lines, wherein the template includes a base plate providing a rectangular cutout extending along its longitudinal axis with a first predetermined width; an arm plate defined in part by a distal arm edge and an opposing proximal arm edge spaced apart by the first predetermined width; and an arm interconnecting the base plate and the arm plate so that the midpoints of the rectangular cutout and the arm plate are a second predetermined distance apart.

In another aspect of the present invention, the template includes a base plate providing a rectangular cutout extending along its longitudinal axis with a first predetermined width, wherein a distance between a periphery of the base plate and the rectangular cutout is a third predetermined distance; an arm plate defined in part by a distal arm edge and an opposing proximal arm edge spaced apart by the first predetermined width; an arm interconnecting the base plate and the arm plate so that the midpoints of the rectangular cutout and the arm plate are a second predetermined distance apart and parallel; a handle transversely joined to the base plate; and a wind guard transversely joined along a periphery of the rectangular cutout on the same side of the base plate as the handle.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is an exploded perspective view of an exemplary embodiment of the present invention, demonstrating use;

FIG. 3 is a perspective view of an exemplary embodiment of the present invention; and

FIG. 4 is a detailed perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system embodying a template for marking all American football field hash and cross marks. The template provides an arm plate and a base plate interconnected by an arm of a predetermined distance. The base plate provides a centrally disposed rectangular cutout for, with a separate marking device, marking the hash and cross marks, wherein the periphery of the base plate in conjunction with the arm plate enable a user to properly locate all the needed hash and cross marks.

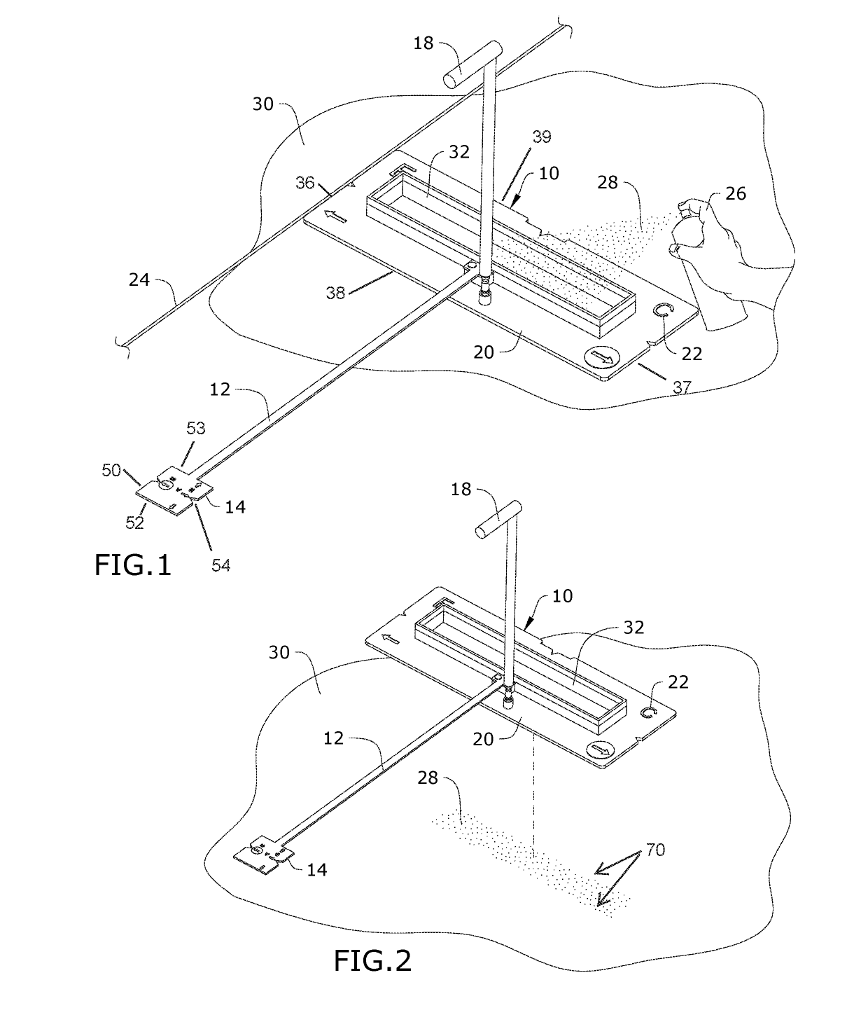

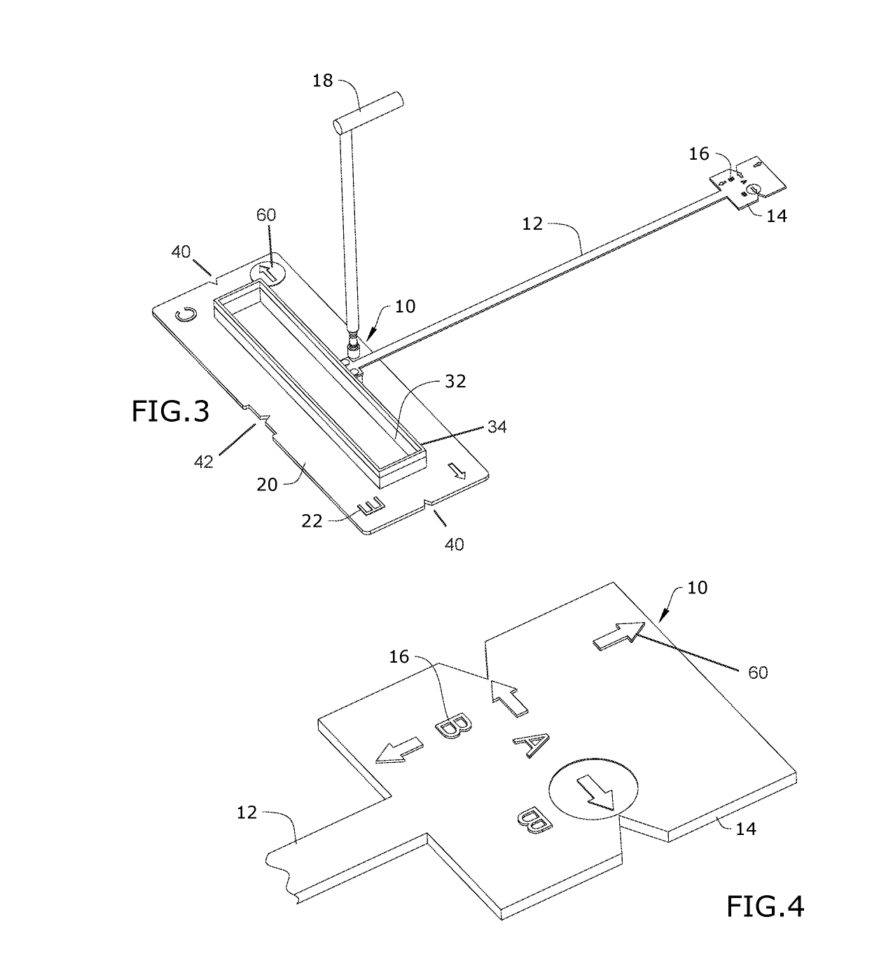

Referring to FIGS. 1 through 4, the present invention may include a template 10 having a base plate 20 and an arm plate 14 interconnected by an arm 12 by a predetermined distance. The template 10 may be made of material of sufficient rigidity, such as various plasticized, various metallic materials, various impregnated or laminated fibrous materials, and the like.

The base plate 20 may be a generally rectangular sheet providing a centrally disposed rectangular cutout 32. The rectangular base plate 20 may be defined by two opposing first and second base side edges 36 and 37 and two opposing first and second base length edges 38 and 39, as illustrated in FIG. 1. Each side base edge 36 and 37 may form a side designator notch 40 at the midpoint thereof. The second length edge 39 may form a length designator notch 42 centered at the midpoint thereof. The length designator notch 42 may extend along the second length edge 39 for a predetermined width of a hash mark and/or the same width of the rectangular cutout 32. The rectangular cutout 32 may be dimensioned to comply with the relevant football league regulations—for example, 4 inches by 24 inches. The base plate 20 may be 12 by 32 inches, so that a 4 inch-wide section of the base plate 20 surrounds the rectangular cutout 32. It being understood that the 4-inch width, especially between the length edges and the rectangular cutout, may be essential for properly locating hash and cross marks per applicable regulations. Circumscribing the rectangular cutout 32 along a periphery thereof, a wind guard 34 may perpendicularly extend from the base plate 20. A handle 18 may perpendicularly extend from the base plate 20 in the same direction as the wind guard 34.

The arm plate 14 may be a generally rectangular sheet defined by two opposing two arm side edges 50 and two opposing arm length edges and distal arm length edge 52 and a proximal arm length edge 53, as illustrated in FIG. 1. Each arm side edge 50 may provide an arm designator notch 54 at the midpoint thereof. The distance between the distal arm length proximal arm length edges 52 and 53 may be the predetermined width (in certain embodiments, 4 inches).

Adjacent each base plate and arm plate notches, side edges, and length edges 40, 42 and 54, 36, 37 and 50, and 38, 39 and 52, respectively, the template 10 may provide a designator indicia 22 and 16 and/or orientation indicia 60. The designator indicia 22 and 16 may take the form of a letter, such as ‘A’, ‘B’, ‘C’, or ‘E’ or the like, for indicating which associated portion of the template 10 should be utilized during the process of using the present invention. Orientation indicia 60 may take the shape of an arrow indicating the direction an associated edge or notch should face during the process of using the present invention.

The arm 12 may be a flat or rounded elongated member and be approximately 32 inches in length, so that the distance between the length designator notch 42 and the arm designator notch 54 is 36 inches or one yard. The arm 12 may be interconnected so that the side and length edges of the base plate 20 are oriented parallel to the respective side and length edges of the arm plate 14, and so that the base and arm plates 20 and 14 are parallel relative to each other.

A method of using the present invention may include the following. The template 10 disclosed above may be provided. A user 26 may provide marking device 28, such as paint, and alignment apparatus 24, such as a string, to define a predetermined perimeter of an American football field 30. Once the user 26 has defined the field of play at an intersection of the sideline and goal line using the alignment apparatus 24, then the user 26 may mark the rectangular cutout 32, forming a starting goal line hash mark in the end zone, wherein the starting goal line is defined by said intersection of the sideline and goal line. Referring to the FIGS. 1 and 2 specifically, then the user 26 may use the handle 18 and move the template 10 so as to place the arm designator notches 54 (in certain embodiments, the designator indicia 22 ‘A’) to align with the starting goal line (most likely still delinieated by the alignment apparatus 24) so that the first base side edge 36 aligns with the adjacent sideline (in certain embodiment, the designator indicia 22 ‘E’ orientation indicia 60 arrow) so that the base plate 20 is in the field of play, and marking with the marking device 28 the rectangular cutout 32, forming the 1-yard line hash. Then the user 26 may manipulate the template 10 so that the distal and proximal arm length edges 52 and 53 align with the opposing hash edges 70 (or in certain embodiment, that the designator indicia 22 ‘A’ aligns with the center) of last painted yard/hash mark, and maintaining the alignment of first base side edges 36 with the adjacent sideline (in the field of play) so as to mark with the marking device 28 the rectangular cutout 32 forming the adjacent hash mark. The user 26 could continue in such a manner to paint all yard and hash marks down the adjacent sideline until reaching the opposing (from where the user started) end zone, stopping at the 1-yard hash mark adjacent thereto. Then the user may place the arm designator notches 54 (in certain embodiments, the designator indicia 22 ‘A’) on the goal side edge of the 1-yard hash mark while maintaining the alignment of first base side edges 36 with the adjacent sideline (alignment apparatus 24) so as to mark with the marking device 28 the rectangular cutout 32 forming the opposing goal line hash mark. Then the user 26 would repeat the steps for the opposing sideline, but using the second base side edges 37. Then the user 26 may paint all sidelines, yard and goal lines; note, the goal line and every 5-yard hash marks get subsumed by these later, full goal and 5-yard lines.

Then the user 26 may measure 53 ft-8 in. from either sideline at each goal line towards the center at all four corners of the football field 30. The user may stake these spots and run the alignment apparatus 24 between to define a midfield line. Then the user 26 may place the template 10 to demark the left and right midfield hash marks in a process similar to the one disclosed above, but using the midfield line instead of the adjacent sideline.

Then the user 26 may mark the 5-yard cross marks by rotating the template 10 so that the length designator notch 42 aligns with the relevant 5-yard line so that the rectangular cutout 32 is orthogonal to said relevant yard line, and the second length edge 39 aligns with the midfield line (alignment apparatus 24) so as to mark the rectangular cutout 32 with the marking device 28, forming the left or side midfield cross. The user may be flip and mirror the template 10 about the midfield line to do the right or left side 5-yard cross marks. Thereby the present invention enables one person to mark the hash marks and midfield cross marks with the same template 10.

The present invention may also be used to demark consistently distanced spectator lines.

It should be understood, of course, that the foregoing relates to exemplary embodiments of the invention and that modifications may be made without departing from the spirit and scope of the invention as set forth in the following claims.

What is claimed is:

1. A device comprising:
a base plate providing a rectangular cutout extending along its longitudinal axis with a first predetermined width;
an arm plate defined in part by a distal arm edge and an opposing proximal arm edge spaced apart by the first predetermined width; and
an arm interconnecting the base plate and the arm plate so that the midpoints of the rectangular cutout and the arm plate are a second predetermined distance apart.

2. The device of claim 1, wherein a distance between a periphery of the base plate and the rectangular cutout is a third predetermined distance.

3. The device of claim 1, further comprising a handle transversely joined to the base plate.

4. The device of claim 1, further comprising a wind guard transversely joined along a periphery of the rectangular cutout.

5. The device of claim 1, wherein the first predetermined distance is four inches.

6. The device of claim 1, wherein the second predetermined distance is 36 inches.

7. The device of claim 1, wherein the third predetermined distance is four inches.

8. A device comprising:
a base plate providing a rectangular cutout extending along its longitudinal axis with a first predetermined width, wherein a distance between a periphery of the base plate and the rectangular cutout is a third predetermined distance;
an arm plate defined in part by a distal arm edge and an opposing proximal arm edge spaced apart by the first predetermined width;
an arm interconnecting the base plate and the arm plate so that the midpoints of the rectangular cutout and the arm plate are a second predetermined distance apart and parallel;
a handle transversely joined to the base plate; and
a wind guard transversely joined along a periphery of the rectangular cutout on the same side of the base plate as the handle.

9. The device of claim 8, wherein the first predetermined distance is four inches.

10. The device of claim 9, wherein the second predetermined distance is 36 inches.

11. The device of claim 10, wherein the third predetermined distance is four inches.
